(19) United States
(12) Patent Application Publication
(10) Pub. No.: US 2004/0117347 A1
(43) Pub. Date: Jun. 17, 2004

(54) Method of managing graphic data and link information thereof for a recording medium

(76) Inventors: Kang Soo Seo, Anyang (KR); Sung Wan Park, Suwon-si (KR); Byung Jin Kim, Sungnam (KR); Soung Hyun Um, Anyang (KR)

Correspondence Address: HARNESS, DICKEY & PIERCE, P.L.C., P.O. BOX 8910, RESTON, VA, 20195, US

(21) Appl. No.: 10/674,507

(22) Filed: Oct. 1, 2003

(30) Foreign Application Priority Data
Oct. 2, 2002 (KR) 10-2002-0060257

(51) Int. Cl. G06F 17/30

(52) U.S. Cl. 707/1

(57) ABSTRACT

A method of managing graphic data for a high-density optical disk is disclosed. High-resolution graphic images associated with a main video image recorded on the high-density optical disk are recorded on the optical disk along with link information to link the graphic images to respective main video images in a file structure suitable for the optical disk. The method allows an efficient management of the graphic images and navigation information and provides various ways of overlaying the graphic images on the associated main video image.

### BACKGROUND OF THE INVENTION

1. Field of the Invention

The present invention relates to a method of managing graphic data for a high-density recording medium such as an optical disk (e.g., a Blu-ray Disc ROM (BD-ROM)).

2. Description of the Related Art

Recording media such as optical disks capable of recording large amounts of high-quality digital video/audio data, for example, DVDs (digital versatile disks) are now commercially available on the market. The types of DVDs include DVD-Video, DVD-VR (Video Recording), DVD-Audio, and DVD-AR (Audio Recording).

In the DVD-Video, graphic data to be reproduced in synchronization with a video/audio data stream is defined by the DVD-private format and designated as sub-pictures.

A sub-picture of the graphic data is of size 720×480 pixels and has a palette with 2-bit color depth, which can support up to 16 colors. The graphic data is recorded on the DVD after being multiplexed with the video/audio stream.

A run-length coding method according to the DVD-Video standard is applied to the graphic data in which display control information about sub-picture data is included. The display control information includes information on display timing, color change, blending ratio change, display position, size selection, etc.

Operations for providing various graphic effects to the graphic data, such as scroll-up/down, fade/wipe-in/out, and color change, can be performed selectively on a time basis. Navigation information for the palette information is defined for each title and program chain and includes information on 16 colors and the number and attributes of sub-pictures.

The attributes of sub-pictures may include caption information, director's comments, and aspect ratio information for various applications as well as coding mode information and language information.

An optical disk reproducing apparatus such as a DVD player displays the main video image and some or all of the graphic image of a sub-picture unit (SPU) as shown in FIG. 1 by blending the images using navigation information, wherein the graphic image of the sub-picture unit (SPU) is overlaid on the main video image on a presentation time basis.

As shown in FIG. 2, sub-picture packs (SP_PCKs) are recorded intermittently among audio packs (Audio_PCKs) and video packs (Video_PCKs) recorded successively. Each of the audio and video packs is of size 2048 bytes.

During data reproduction, the sub-picture packs are read and then grouped into a sub-picture unit (SPU), which includes a sub-picture unit header, pixel data, and display control information.

The sub-picture unit header includes the data size of the sub-picture unit. The pixel data includes 2-bit depth bitmap data encoded by the run-length coding method. The palette information for the pixel data is recorded as separate navigation information.

The optical disk reproducing apparatus reproduces the pixel data along with the audio and video data, the pixel data being synchronized with the audio and video data. As alluded to above, the apparatus displays the main video image and some or all of the graphic image of a sub-picture unit (SPU) by blending the images using the navigation information, wherein the graphic image of the sub-picture unit (SPU) is overlaid on the main video image in various ways on a presentation time basis.

The standardization for high-density read-only optical disks such as the Blu-ray disc ROM (BD-ROM) is still under way. A method for effective managing graphic data and navigation data thereof recorded on the high-density read-only optical disk such as a BD-ROM is not yet available.

### SUMMARY OF THE INVENTION

It is an object of the present invention to provide a method of managing graphic images for a high-density optical disk in which graphic images associated with main video of the optical disk and graphic link information for the graphic images are recorded in a file structure suitable for the high-density optical disk.

A method of recording graphic data on a recording medium in accordance with the present invention is characterized in that it comprises: recording a plurality of graphic images pertaining to a main video image separately with the main video image; and recording graphic link information to link the plurality of graphic images with the main video image for overlaying the main video image with the plurality of graphic images.

Another method of recording graphic data on a recording medium in accordance with the present invention is characterized in that it comprises: organizing at least one graphic image constituting a main video image and graphic link information as respective files, the graphic link information linking the graphic images with the main video image for overlaying the main video image with the graphic images; and placing the graphic image file and the graphic link information file under a specific directory defined by a file structure of the recording medium or under at least one subdirectory created below the specific directory.

A high-density read-only recording medium whose data is structured in accordance with the present invention is characterized in that it includes; at least one main video image; at least one graphic image file containing a graphic image; and at least one graphic link information file containing information to link the graphic images with the main video images for overlaying each main video image with the graphic images, wherein the graphic image file and the graphic link information file have been written under a specific directory defined by a file structure of the recording medium or under at least one subdirectory created below the specific directory.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates a graphical representation of main video overlaid with graphic images according to the DVD-Video standard;

FIG. 2 illustrates a structure of graphic data in the DVD-Video standard;

FIG. 3 illustrates a graphical representation of an embodiment of a method of managing graphic data for a high-density recording medium in accordance with the invention;

FIG. 4 illustrates a graphical representation of the main data overlaid with a plurality of graphic images of different sizes and color depths;

FIGS. 5-8 illustrate graphic images and graphic information managed by preferred embodiments of a method of managing graphic data for a high-density optical disk in accordance with the present invention; and

FIGS. 9-15 illustrate various embodiments of a file structure for effectively storing graphic images in accordance with the invention.

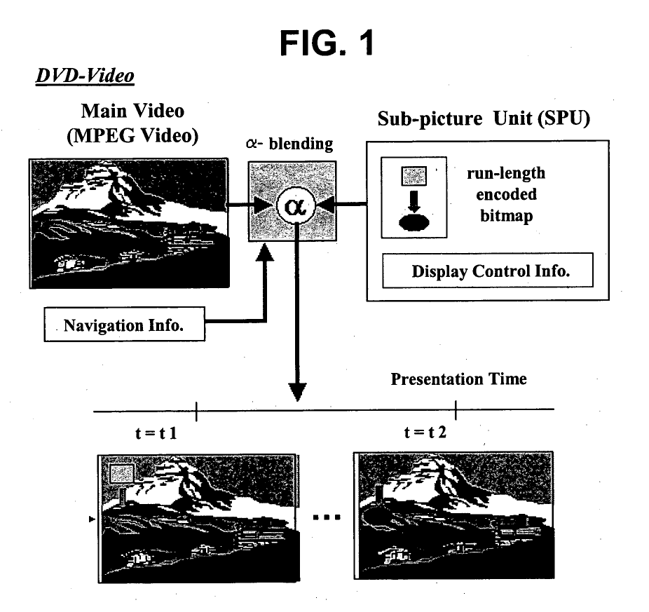

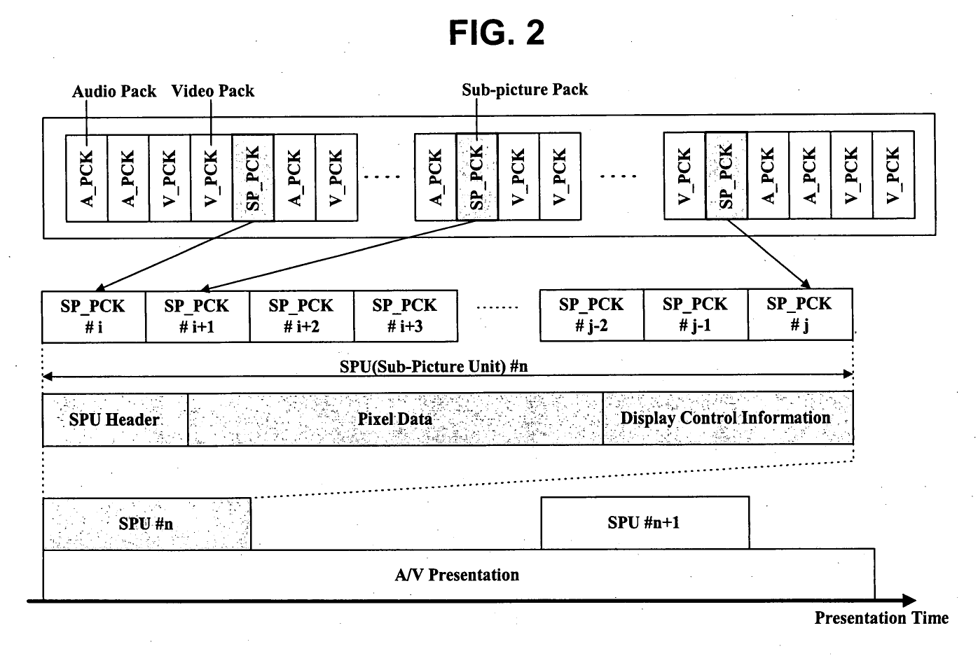

### DETAILED DESCRIPTION OF THE PREFERRED EMBODIMENTS

In order that the invention may be fully understood, preferred embodiments thereof will now be described with reference to the accompanying drawings.

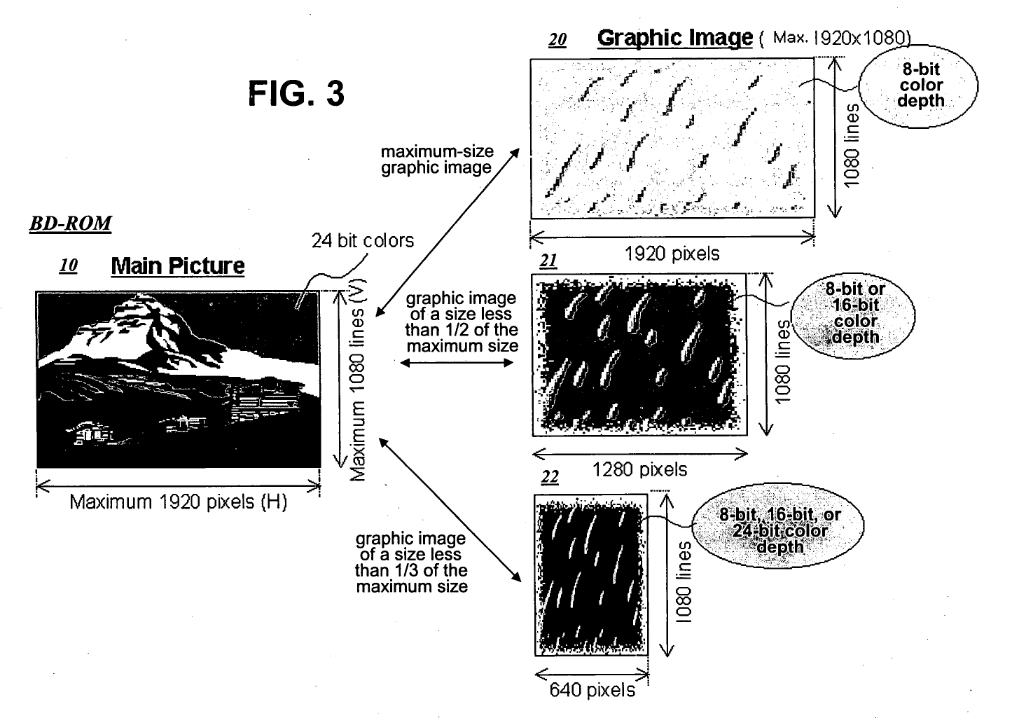

FIG. 3 is a graphical representation of an embodiment of a method of managing graphic data for a high-density recording medium such as an optical disk in accordance with the present invention. A main picture image has one or more corresponding graphic images, which have different sizes and color depths.

As shown, the main picture of size 1920×1080 pixels has three different associated graphic images, a graphic image of size 1920×1080 pixels, a graphic image of size 1280×1080 pixels, and a graphic image of size 640×1080 pixels.

The three graphic images have different color depths. The 1920×1080 graphic image has an 8-bit color depth, the 1280×1080 graphic image has an 8-bit or 16-bit color depth, and the 640×1080 graphic image has an 8-bit, 16-bit, or 24-bit color depth.

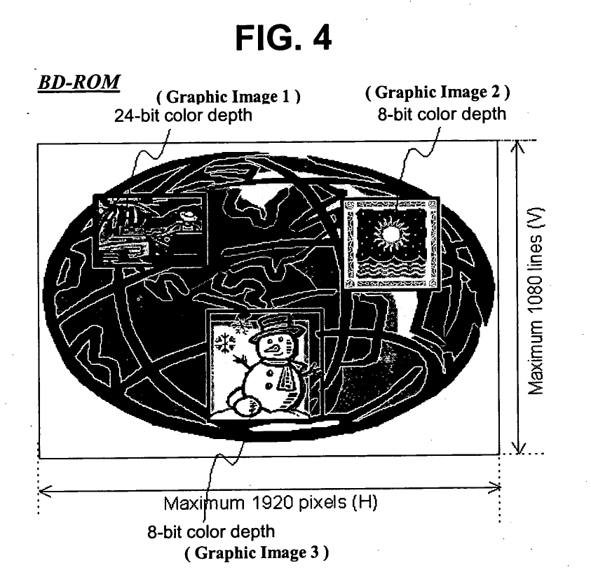

As shown in FIG. 4, a plurality of different graphic images, the graphic images 1, 2, and 3, can be simultaneously overlaid on one main picture image and the plurality of graphic images may have different sizes and color depths. The plurality of graphic images can be managed individually or as a group.

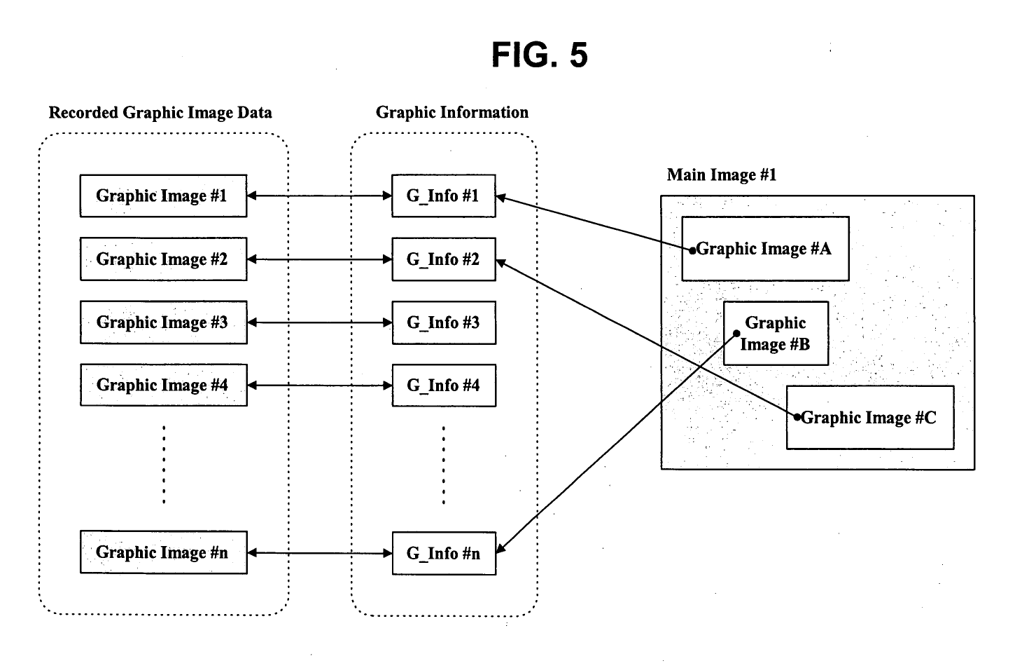

In the first embodiment of a method of managing a plurality of graphic images individually as shown in FIG. 5, a plurality of graphic images (Graphic Image #1˜Graphic Image #n) are recorded individually without regard to main video images. That is, the graphic images are recorded separately with main video images.

Graphic link information for the individually recorded graphic images is created and organized as multiple pieces of associated graphic information (G_Info #1˜G_Info #n). One or more graphic images (e.g., Graphic Images #A, #B, and #C) may be simultaneously overlaid on one main video image (e.g., Main Image #1).

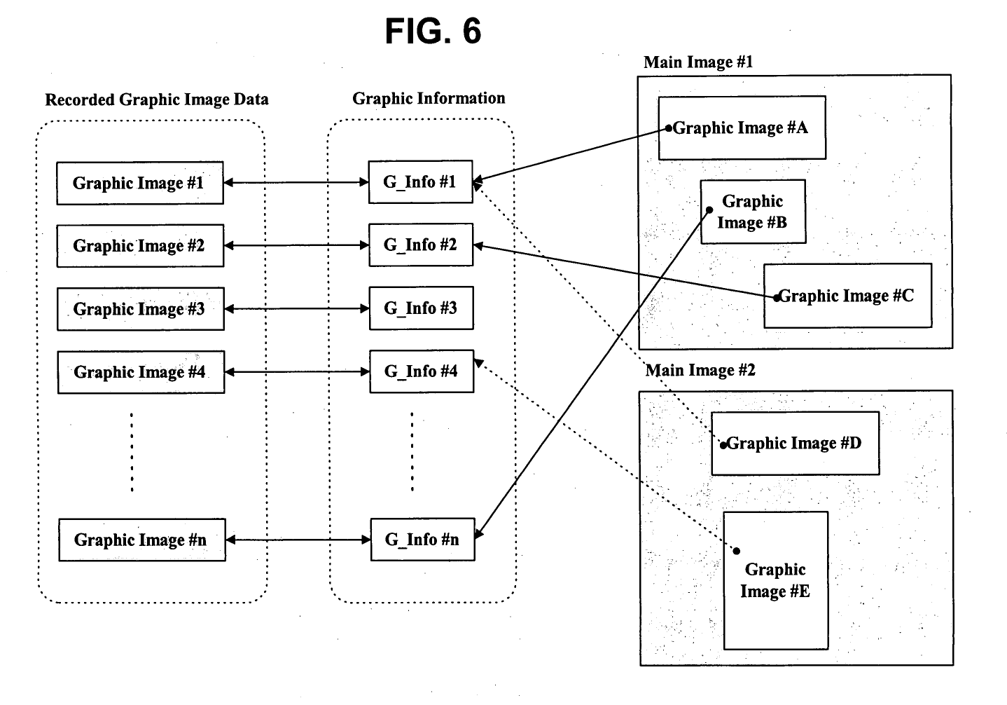

In the second embodiment of a method of managing a plurality of graphic images individually as shown in FIG. 6, a plurality of graphic images (Graphic Image #1˜Graphic Image #n) are recorded individually without regard to main video images. Graphic link information for the individually recorded graphic images is created and organized as multiple pieces of associated graphic information (G_Info #1˜G_Info #n). One or more graphic images may be simultaneously overlaid on one main video image (e.g., Main Image #1). Further, one graphic image may be used to be overlaid on different main video images (e.g., Main image #1 and Main image #2).

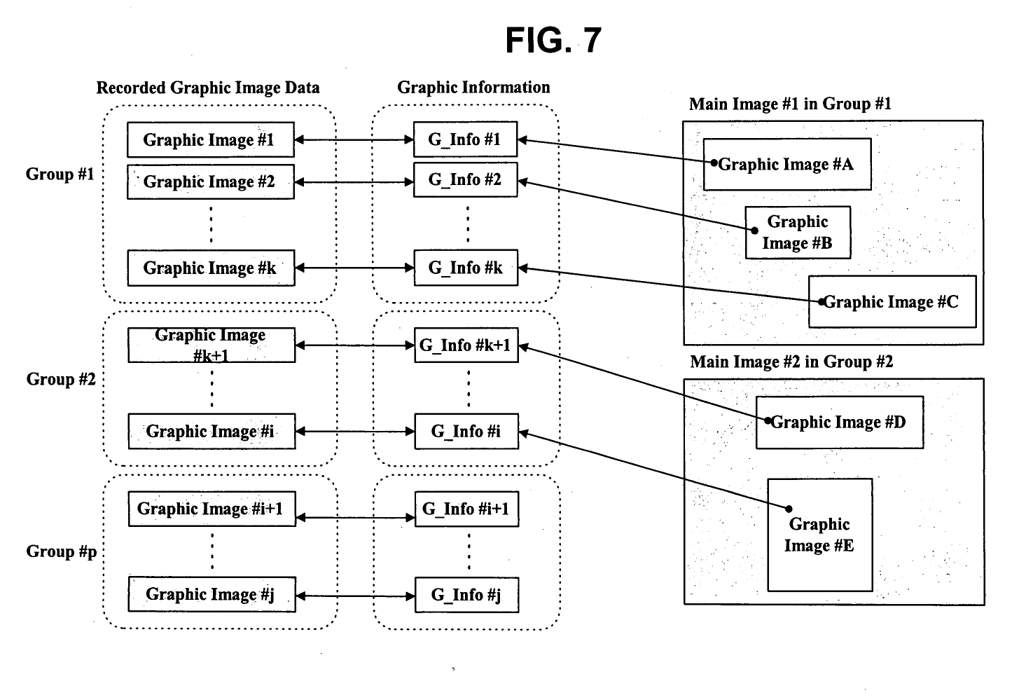

In the third embodiment of a method of managing a plurality of graphic images individually as shown in FIG. 7, a plurality of graphic images (Graphic Image #1˜Graphic Image #n) are recorded individually without regard to main video images. In this embodiment, however, the graphic images are organized into a plurality of groups (Group #1˜Group #p), each of which is associated with a title or a playlist.

Graphic link information for the individually recorded graphic images is created and organized as multiple pieces of associated graphic information (G_Info #1˜G_Info #j), which are also organized into a plurality of groups in the same manner that the graphic images are organized into the groups.

One or more graphic images may be simultaneously overlaid on one main video image (e.g., Main Image #1); however, graphic images pertaining to one group can be overlaid only on the main video image of the same group (e.g., Graphic Images #1 to #k if Main Image #1 in Group #1).

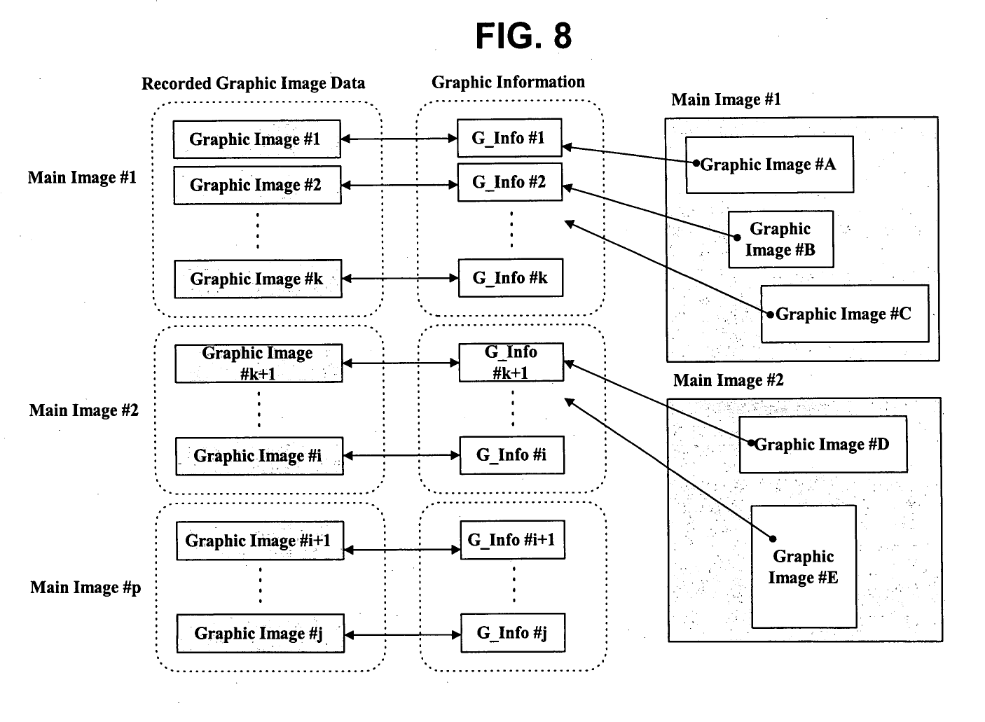

In the fourth embodiment of a method of managing a plurality of graphic images individually as shown in FIG. 8, a plurality of graphic images associated with a main video image are recorded sequentially.

In this embodiment, one graphic image recorded on a recording medium is not shared by two or more main video images. However, one main video image can use one graphic image more than once.

Next, methods of recording and managing the graphic images and graphic link information described above in a file structure suitable for a BD-ROM will be described in detail.

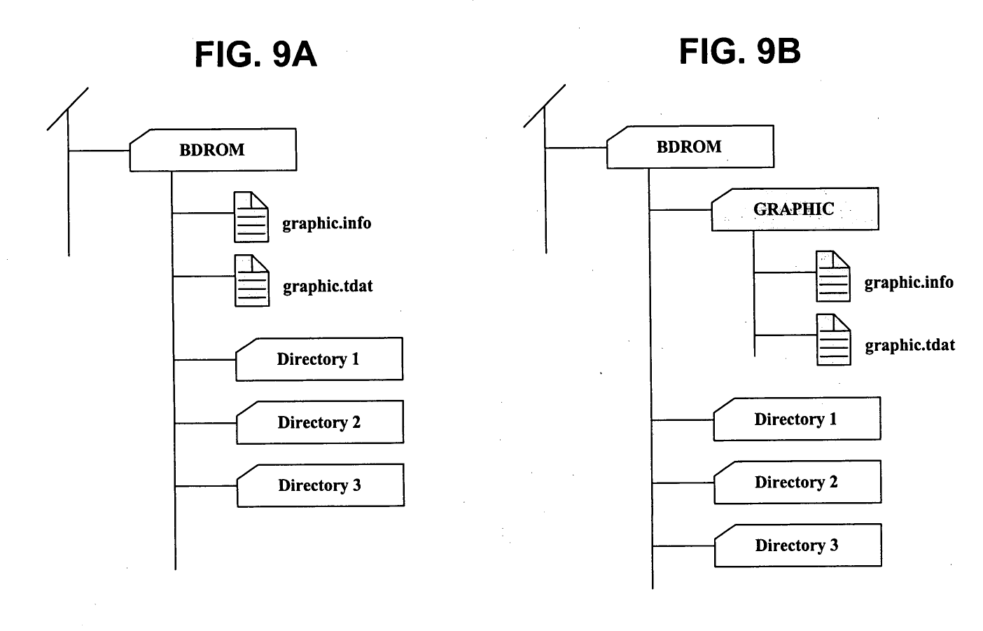

In the first embodiment, illustrated in FIG. 9A, of a file structure according to the present invention, multiple pieces of graphic link information are organized as a single graphic information file (e.g., ‘graphic.info’) and a plurality of graphic images are organized as a single graphic image data file (e.g., ‘graphic.tdat’).

The graphic information file ‘graphic.info’ and the graphic image data file ‘graphic.tdat’ are stored in a directory named ‘BDROM’ under a root directory.

In the second embodiment, illustrated in FIG. 9B, of a file structure, a ‘GRAPHIC’ directory is newly defined under the ‘BDROM’ directory and the graphic information file ‘graphic.info’ and the graphic image data file ‘graphic.tdat’ are stored in the ‘GRAPHIC’ directory.

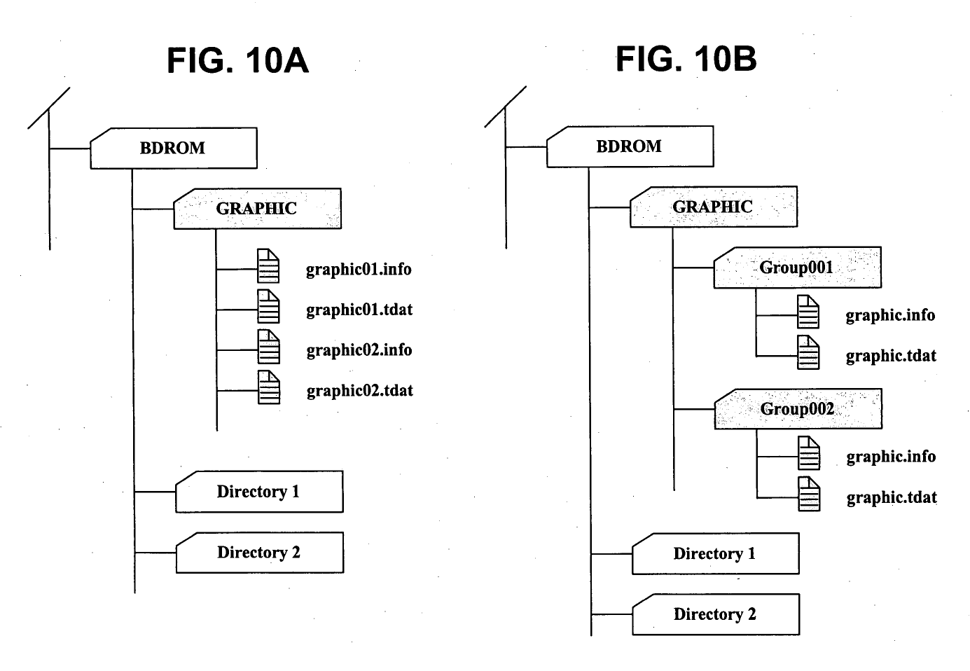

In the third embodiment, illustrated in FIG. 10A, of a file structure, multiple pieces of graphic information and a plurality of graphic images associated with each group are organized as a graphic information file (e.g., ‘graphic0x.info’) and a graphic image data file (e.g., ‘graphic0x.tdat’), respectively, wherein a group corresponds to a title or a playlist.

All graphic information files (e.g., ‘graphic01.info’, ‘graphic02.info’, . . . ) and all graphic image data files (e.g., ‘graphic01.tdat’, ‘graphic02.tdat’, . . . ) associated with a plurality of groups are stored in a ‘GRAPHIC’ directory created under the ‘BDROM’ directory.

In the fourth embodiment, illustrated in FIG. 10B, of a file structure, a graphic information file (e.g., ‘graphic.info’) and a graphic image data file (e.g., ‘graphic.tdat’) created for each group are stored in a directory (e.g., ‘Group001’ if they pertain to Group 1) related with the group. Those group directories ‘Group 00x’ are created under the ‘GRAPHIC’ directory.

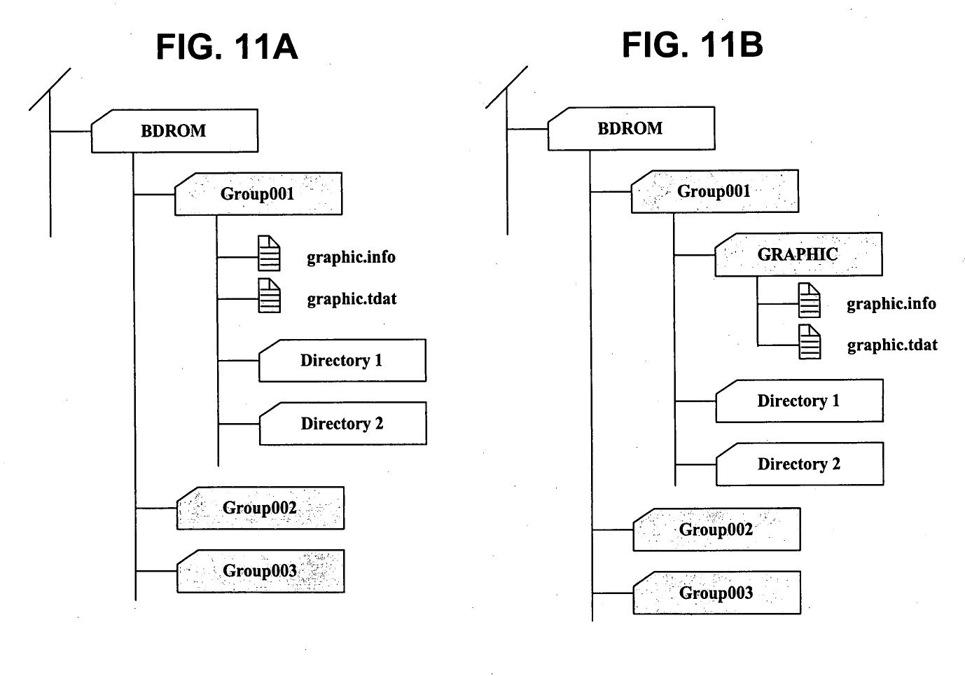

In the fifth embodiment of a file structure, as shown in FIG. 11A, group directories (e.g., ‘Group001’, ‘Group002’, . . . ) are created in the BDROM directory and a graphic information file (e.g., ‘graphic.info’) and a graphic image data file (e.g., ‘graphic.tdat’) associated with each group are stored in the corresponding group directory.

In the sixth embodiment of a file structure, as shown in FIG. 11B, group directories (e.g., ‘Group001’, ‘Group002’, . . . ) are created in the ‘BDROM’ directory and a ‘GRAPHIC’ directory is created in each group directory. A graphic information file (e.g., ‘graphic.info’) and a graphic image data file (e.g., ‘graphic.tdat’) associated with each group are stored in the ‘GRAPHIC’ subdirectory of the corresponding group directory.

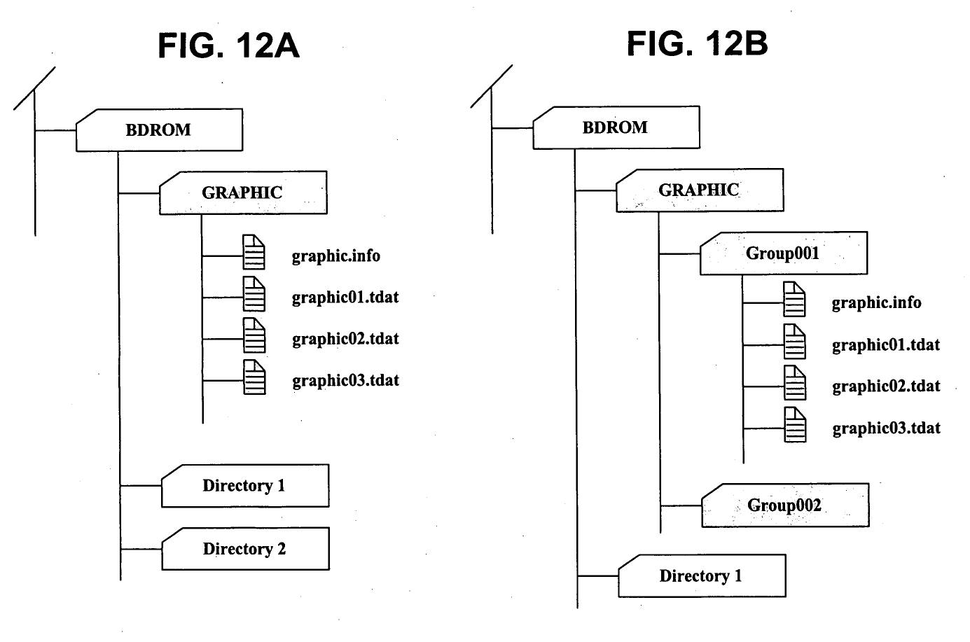

In the seventh embodiment of a file structure, as shown in FIG. 12A, multiple pieces of graphic information are organized as a single graphic information file (e.g., ‘graphic.info’) and a plurality of graphic images are organized as individual graphic image data files, namely, ‘graphic01.tdat’, ‘graphic02.tdat’, . . . . The single graphic information file and graphic image data files are stored in a ‘GRAPHIC’ directory created in the ‘BDROM’ directory.

In the eighth embodiment of a file structure, as shown in FIG. 12B, multiple pieces of graphic information and a plurality of graphic images associated with each group are organized as a single graphic information file (e.g., ‘graphic.info’) and individual graphic image data files (e.g., ‘graphic01.tdat’, ‘graphic02.tdat’, . . . ), respectively, wherein a group is related with a title or a playlist.

Group subdirectories named ‘Group001’, ‘Group002’, . . . ) are created in a ‘GRAPHIC’ directory contained in the ‘BDROM’ directory and the single graphic information file ‘graphic.info’ and the graphic image data files (e.g., ‘graphic01.tdat’, ‘graphic02.tdat’, . . . ) associated with each group are stored in the corresponding group subdirectory.

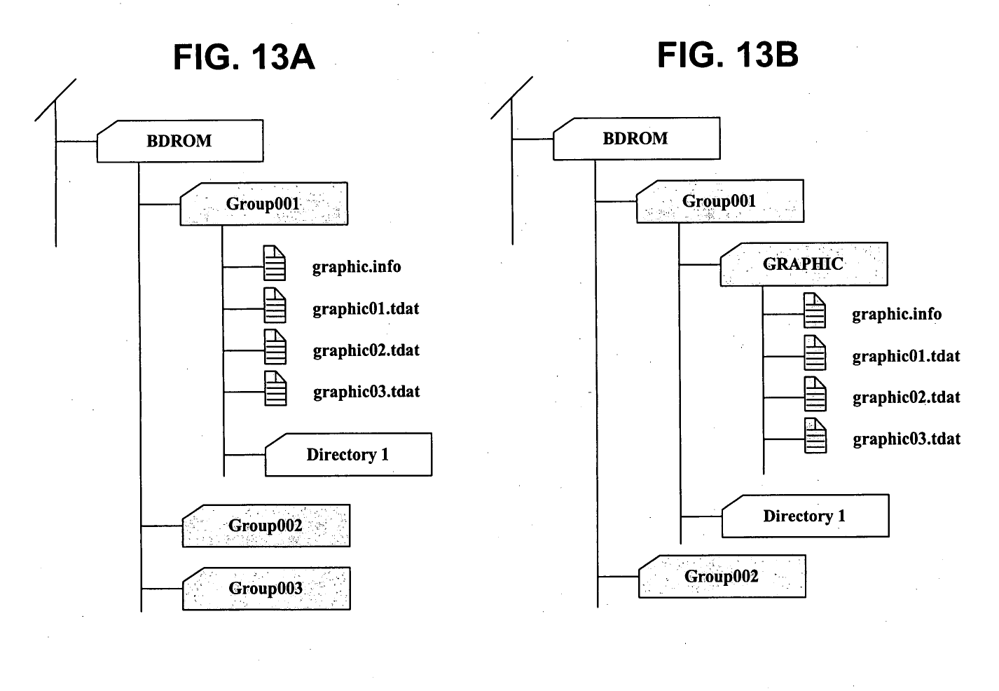

In the ninth embodiment of a file structure, as shown in FIG. 13A, group directories named ‘Group001’, ‘Group002’, . . . ) are defined in the ‘BDROM’ directory and a single graphic information file ‘graphic.info’ and graphic image data files named ‘graphic01.tdat’, ‘graphic02.tdat’, . . . ) associated with each group are stored in the corresponding group directory.

In the tenth embodiment of a file structure illustrated in FIG. 13A, group directories ‘Group001’, ‘Group002’, . . . ) are defined in the ‘BDROM’ directory and a single graphic information file ‘graphic.info’ and graphic image data files ‘graphic01.tdat’, ‘graphic02.tdat’, . . . ) associated with each group are stored in a ‘GRAPHIC’ directory created under the corresponding group directory.

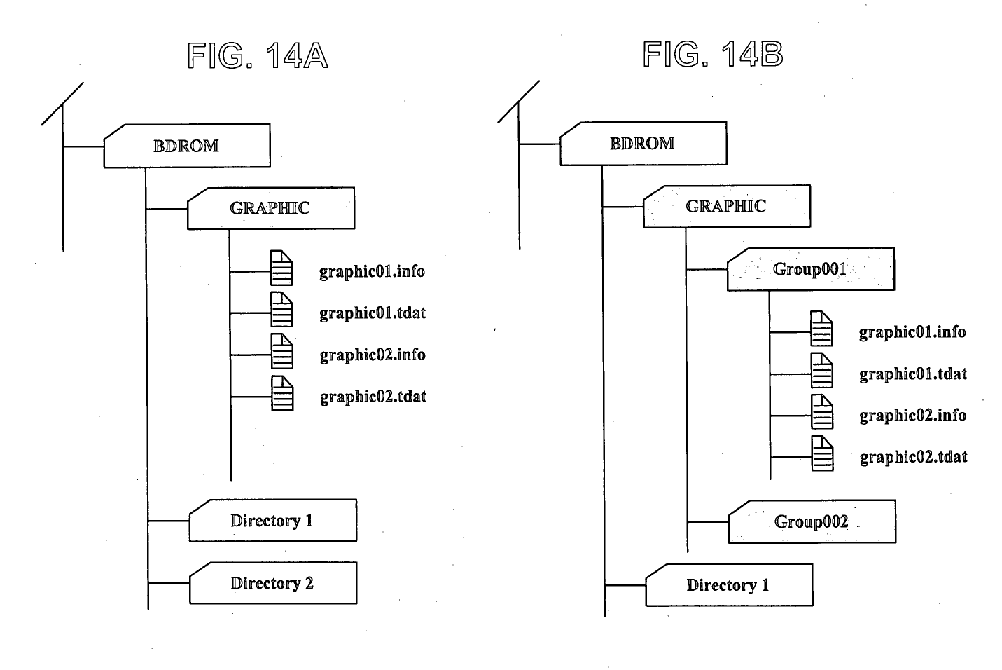

In the eleventh embodiment of a file structure illustrated in FIG. 14A, multiple pieces of graphic information are organized as a single graphic information file for each group or individual graphic information files. Likewise, a plurality of graphic images are organized as a single graphic image data file for each group or individual graphic image data files.

The plurality of graphic information files and the graphic image data files are stored in a ‘GRAPHIC’ directory created under the ‘BDROM’ directory, wherein each graphic information file has information to link its graphic information to each graphic image data file or each graphic image contained in a graphic image data file.

In the twelfth embodiment of a file structure illustrated in FIG. 14B, group directories (e.g., Group001, Group002, . . . ) are defined in a ‘GRAPHIC’ directory under the ‘BDROM’ directory. The graphic information file or files (in case that each piece of graphic information is organized as a single file) and graphic image data files related with each group are stored in a corresponding group directory.

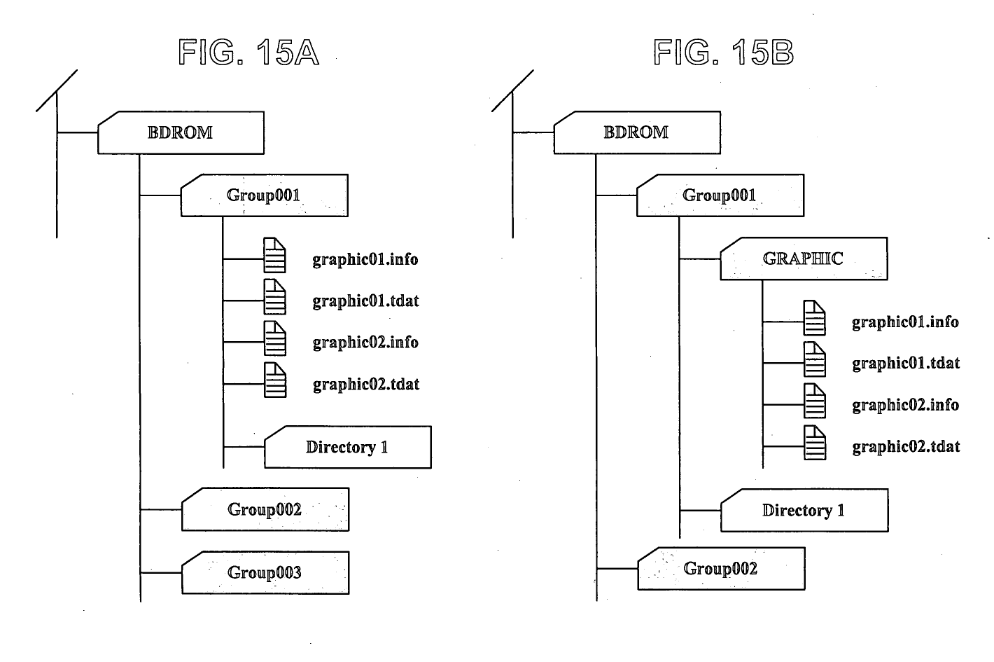

In the thirteenth embodiment of a file structure illustrated in FIG. 15A, group directories (e.g., ‘Group001’, ‘Group002’, . . . ) are created in the ‘BDROM’ directory and the graphic information file or files and graphic image data files for each group are stored in a corresponding group directory.

In the fourteenth embodiment of a file structure illustrated in FIG. 15B, the group directories ‘Group001’, ‘Group002’, . . . ) are created in the BDROM directory and the graphic information file or files and graphic image data files are stored in a ‘GRAPHIC’ subdirectory created under a corresponding group directory.

The method of managing graphic data for a high-density optical disk in accordance with the invention efficiently manages large amounts of graphic data and navigation information and allows high-resolution graphic images to be overlaid on main video being reproduced from the high-density optical disk in various ways.

While the invention has been disclosed with respect to a limited number of embodiments, those skilled in the art, having the benefit of this disclosure, will appreciate numerous modifications and variations therefrom. For example, while described with respect to a Blu-ray ROM optical disk in several instances, the present invention is not limited to this standard of optical disk or to optical disks. It is intended that the appended claims cover all such modifications and variations as fall within the true spirit and scope of the invention.

What is claimed is:

1. A method of recording graphic data on a recording medium, comprising:
(a) recording a plurality of graphic images pertaining to a main video image separately with the main video image; and
(b) recording graphic link information to link the plurality of graphic images with the main video image for overlaying the main video image with the plurality of graphic images.

2. The method set forth in claim 1, wherein said plurality of graphic images and graphic link information are grouped based on said main video image.

3. The method set forth in claim 1, wherein said plurality of graphic images and graphic link information are grouped based on a title or a playlist of the recording medium.

4. The method set forth in claim 1, wherein a piece of said graphic link information associates a single graphic image with a plurality of different main video images.

5. The method set forth in claim 1, wherein a piece of said graphic link information associates a single graphic image with a single main video image.

6. A method of recording graphic data on a recording medium, comprising;
(a) organizing at least one graphic image constituting a main video image and graphic link information as respective files, the graphic link information linking the graphic images with the main video image for overlaying the main video image with the graphic images; and
(b) placing the graphic image file and the graphic link information file under a specific directory defined by a file structure of the recording medium or under at least one subdirectory created below the specific directory.

7. The method set forth in claim 6, wherein the specific directory is a child directory of a root one, and has a name indicative of ‘read-only’.

8. The method set forth in claim 6, wherein the subdirectory is created for each group of the graphic image files.

9. The method set forth in claim 6, wherein the single graphic image is organized to the single graphic image file.

10. The method set forth in claim 6, wherein all of the graphic images to constitute a plurality of main video images are organized to the single graphic image file.

11. The method set forth in claim 6, wherein a plurality of the graphic images pertaining to same group are organized to the single graphic image file.

12. The method set forth in claim 6, wherein the single graphic link information file is constituted by information to link the single graphic image to the main video image.

13. The method set forth in claim 6, wherein the single graphic link information file is constituted by information to link all of the graphic images to corresponding main video images, respectively.

14. The method set forth in claim 6, wherein the single graphic link information file is constituted by information to link a plurality of the graphic images pertaining to same group to corresponding main video images, respectively.

15. The method set forth in claim 6, wherein the graphic images are grouped based on a title or a playlist which they pertain to.

16. A recording medium, comprising:
at least one main video image;
at least one graphic image file containing a graphic image; and
at least one graphic link information file containing information to link the graphic images with the main video images for overlaying each main video image with the graphic images, wherein the graphic image file and the graphic link information file have been written under a specific directory defined by a file structure of the recording medium or under at least one subdirectory created below the specific directory.

17. The recording medium set forth in claim 16, wherein the specific directory is a child directory of a root one, and has a name indicative of ‘read-only’.

18. The recording medium set forth in claim 16, wherein the subdirectory is created for each group of the graphic image files.

19. The recording medium set forth in claim 16, wherein the single graphic image file contains the single graphic image.

20. The recording medium set forth in claim 16, wherein the single graphic image file contains all of the graphic images to constitute the plurality of main video images.

21. The recording medium set forth in claim 16, wherein the single graphic image file contains some of the graphic images pertaining to same group.

22. The recording medium set forth in claim 16, wherein the single graphic link information file has been constituted by information to link all of the graphic images to corresponding main video images, respectively.

23. The recording medium set forth in claim 16, wherein the single graphic link information file has been constituted by information to link a plurality of the graphic images pertaining to same group to corresponding main video images, respectively.

24. The recording medium set forth in claim 16, wherein the graphic images have been grouped based on a title or a playlist which they pertain to.
